(19) United States
(12) Patent Application Publication
(10) Pub. No.: US 2022/0287339 A1
(43) Pub. Date: Sep. 15, 2022

(54) RAW-MATERIAL CONCENTRATE WITH ENHANCED FLAVOR AND PREPARATION METHOD THEREFOR

(71) Applicant: CJ CHEILJEDANG CORPORATION, Seoul (KR)

(72) Inventors: Jin Hee HAN, Suwon-si, Gyeonggi-do (KR); Seung Yun YIM, Suwon-si, Gyeonggi-do (KR)

(73) Assignee: CJ CHEILJEDANG CORPORATION, Seoul (KR)

(21) Appl. No.: 17/638,331

(22) PCT Filed: Sep. 25, 2020
(86) PCT No.: PCT/KR2020/013032

§ 371 Date: Feb. 25, 2022

(30) Foreign Application Priority Data
Sep. 27, 2019 (KR) 10-2019-0119271

(51) Int. Cl. A23L 5/00; A23L 19/00; A23L 5/20

(52) U.S. Cl. CPC A23L 5/51; A23L 19/00; A23L 5/21; A23V 2002/00

(57) ABSTRACT

The present application relates to a raw-material concentrate with enhanced flavor and a novel preparation method therefor. According to the preparation method of the present application, it is possible to provide a raw-material concentrate that has a high extraction yield of active ingredients extracted from raw materials and is economical, and has good flavor as well as less nutrition destruction, and thus has excellent productivity. This raw-material concentrate can be utilized as a food material.

### TECHNICAL FIELD

The present application relates to a raw-material concentrate with enhanced flavor and a novel preparation method therefor.

### BACKGROUND ART

In accordance with an increase in consumer demand for healthy and natural materials, attempts have been made to increase the use of natural ingredients for processed foods and the efforts to avoid use of chemical food additives have been accelerated. Against this backdrop, concentrates of fruits, vegetables, or fruit vegetables keep nutrients of raw materials as they are, and may thus be used as materials for various processed foods.

Typically, these concentrates of fruits, vegetables, or fruit vegetables are prepared by heating and decomposing, and then concentrating fruits, vegetables, or fruit vegetables, but during the process, nutrients are excessively lost and unique flavor and savor of raw materials are reduced.

In particular, when solid content is increased up to high brix through a concentration process, impurities increase and active ingredients are relatively reduced, making it hard to use as materials for processed foods.

### DISCLOSURE OF THE INVENTION

### Technical Problem

The present application provides a new method for preparing a raw-material concentrate that has a high extraction yield of active ingredients extracted from raw materials and thus is economical, and has good flavor as well as less nutrition destruction, and thus has excellent product quality.

The present invention also provides a method for enhancing the flavor of a raw-material concentrate.

The present application also provides a raw-material concentrate with enhanced flavor.

The present application also provides a food containing the raw-material concentrate.

### Technical Solution

To solve the tasks, the present application provides a method for preparing a raw-material concentrate, the method comprising: concentrating raw-material juice by thin-film concentration; and concentrating the thin film-concentrated raw-material juice by plate-concentration. In addition, the present application provides a method for enhancing the flavor of a raw-material concentrate, the method comprising: concentrating a raw-material juice by thin-film concentration; and concentrating the thin film-concentrated raw-material juice by plate-concentration.

In addition, the present application provides an onion concentrate comprising 600 μg/ml or more of thiosulfinate.

In addition, the present application provides a food comprising the onion concentrate.

Hereinafter, the present application will be described in more detail.

In an aspect, the present application provides a method for preparing a raw-material concentrate, the method comprising: concentrating raw-material juice by thin-film concentration; and concentrating the thin film-concentrated raw-material juice by plate-concentration. As used in the present application, the term “raw material” or “raw ingredient” refers to a material in its natural state without being processed, and the term “natural” indicates no involvement of chemical reactions. Specifically, as used herein, the raw material indicates a plant in the form of a raw material having unique flavor, and the plant may be fruits, fruit vegetables (fruit-bearing vegetables), or vegetables.

Specifically, the vegetables may be at least one selected from the group consisting of red pepper, wasabi, Perilla frutescens, codonopsis lanceolate, balloon flower, garlic, ginger, mugwort, turnip, onion, leek, allium monanthum, allium hookeri, bok choy, green onion, kale, rosemary, rutabaga, basil, mint, celery, crown daisy, and parsley. Specifically, the vegetables may be a plant belonging to Allium genus including onion, garlic, green onion, leek, and allium monanthum, but are not limited thereto.

In the present application, “raw-material juice” refers to a liquid obtained by juicing a raw material in order to keep unique flavor.

The solid content of the raw-material juice may be 1 Brix° to 15 Brix°, specifically 1 Brix° to 10 Brix°, 3 Brix° to 10 Brix°, 5 Brix° to 9 Brix, 6 Brix° to 8 Brix°, or 7 Brix° to 8 Brix°.

The raw-material juice may have a turbidity of 120 to 160 NTU, for example, 125 to 160 NTU, or 130 to 155 NTU.

When the turbidity of the raw-material juice is within the above range, suspended matters may hardly form a hard layer in a concentration process due to a low amount of the suspended matters in the raw-material juice, and a combined concentration process may be performed.

The turbidity of the raw-material juice may be a value measured with respect to the solid content of the raw-material juice, and may be a value measured with respect to 7 Brix°.

The method for preparing the raw-material concentrate may be performing the plate-concentration after the thin film-concentration.

When the thin film-concentration and the plate-concentration are combined, raw materials may keep components without deformation or derive new useful components.

In an example embodiment, when the combined concentration according to the present application is performed in the order of plate-concentration after thin film-concentration, the thin film-concentration may be performed until the solid content reaches 20 Brix° to 50 Brix°.

The solid content of the raw-material juice obtained after the thin film-concentration of the present application may have a lower limit of 20 Brix°, 21 Brix°, 22 Brix°, 23 Brix, 24 Brix°, 25 Brix, 30 Brix°, 35 Brix, 40 Brix°, or 45 Brix °, and an upper limit of 50 Brix°, 49 Brix°, 48 Brix°, 47 Brix°, 46 Brix°, 45 Brix°, 40 Brix°, 35 Brix°, 30 Brix, or 25 Brix°. In addition, the solid content of the raw-material juice obtained after the thin film-concentration may be in the range in which one selected from the lower limits described above is combined with one selected from the upper limits described above, and may be, for example, 20 Brix° to 50 Brix°, greater than 20 Brix° to 50 Brix°, 25 Brix° to 50 Brix°, 25 Brix° to 45 Brix°, or 25 Brix° to 40 Brix°, and the like.

In an example embodiment, when plate-concentration is performed after the thin film-concentration, the plate-concentration may be performed until the solid content of a concentrate reaches 60 Brix° or more.

The solid content of a raw-material concentrate finally prepared through the preparation method of the present application may have a lower limit of 60 Brix°, 65 Brix°, 70 Brix°, 75 Brix°, 76 Brix°, 77 Brix°, 78 Brix°, or 79 Brix° °, and an upper limit of 80 Brix°, 75 Brix°, 70 Brix°, 65 Brix°, 64 Brix°, 63 Brix°, 62 Brix°, or 61 Brix°. In addition, the solid content of a raw-material concentrate finally prepared through the preparation method of the present application may be in the range in which one selected from the lower limits described above is combined with one selected from the upper limits described above, and may be, for example, 60 Brix° to 80 Brix°, greater than 60 Brix° to 80 Brix°, 62 Brix° to 78 Brix°, or 65 Brix° to 76 Brix°, and the like.

The thin film-concentration process may be performed without limitation as long as the evaporation temperature of a thin film-concentrator is a temperature that allows raw-material juice to evaporate, and specifically, the process may be performed at 20° C. to 50° C. For example, the thin film-concentration process may be performed at 25° C. to 45° C., 30° C. to 40° C., 30° C. to 38° C., 30° C. to 36° C., or 30° C. to 35° C.

After the thin film-concentration, the process may be repeated until the solid content of a concentrate reaches a level of the solid content Brix° described above.

The plate-concentration process may be performed without limitation as long as the evaporation temperature of a plate-concentrator is a temperature that allows raw-material juice to evaporate, and specifically, the process may be performed at 20° C. to 50° C. For example, the plate-concentration process may be performed at 25° C. to 45° C., 30° C. to 40° C., 30° C. to 38° C., 30° C. to 36° C., or 30° C. to 35° C.

In another example, a difference in the evaporation temperature between the plate-concentrator and the thin film-concentrator may be within 10° C., within 8° C., within 6° C., or within 5° C.

The plate-concentration process may be repeated until the solid content of a concentrate reaches a level of the solid content Brix° described above.

The preparation method of the present application may further include preparing raw-material juice before the thin film-concentration.

The preparing of the raw-material juice may include juicing a raw material, and may include any one or more processes of removing raw material pericarp, controlling raw material bacteria, grinding, and filtering.

The processes of removing raw material pericarp, controlling raw material bacteria, grinding, and filtering may be performed before the juicing of raw-material juice.

The filtering may be performed after the juicing of raw-material juice.

The juicing of raw-material juice is to obtain useful components from a raw material in the form of a liquid, and juicing methods may be used without limitation, but a juicing method through pressing or a juicing method through heating may be used. For example, gear-type juicing, press-type juicing, grinding-type juicing, or enzyme-decomposition-type juicing may be used.

The removing pericarp of raw material is to separate an edible portion of the raw material, and removal methods may be used without limitation.

The controlling bacteria of raw material is to prevent bacteria from growing in a raw material, or to have bacteria get removed, and methods thereof may be used without limitation, but methods for controlling bacteria using heating, pH adjustment, or electrolyzed water may be used. Specifically, a method for controlling bacteria using electrolyzed water may be used, and the method may add hypochlorite ions (OCl—) to a raw material to control bacteria. The hypochlorite ions may be used without limitation as long as materials are in a known form such as hypochlorous acid water (HOCl) or sodium hypochlorite (NaOCl).

The grinding may be performed without limitation as long as methods for increasing juicing efficiency of a raw material are used.

The filtering is to reduce an amount of suspended matters of a juiced raw material, and known methods such as a filtering filter, a filtering membrane, chromatography, or centrifugal separation may be used without limitation.

The filtering may be repeated at least twice or more. The filtering may be performed through at least two filtering processes.

When the filtering is performed through at least two processes, each process may be divided and performed in consideration of the size or nature of a material to be filtered.

In an example embodiment, when the filtering according to the present application is performed through two or more filtering processes, the filtering may include a filter press filtering process. The filter press filtering process may be performed by adding 3 wt % to 7 wt % of diatomaceous earth to raw-material juice with respect to the total weight of the raw-material juice, and specifically, may be performed by adding 5 wt % of diatomaceous earth.

According to the filter press filtering process, suspended matters contained in juice juiced in a raw material state agglomerate and low molecular weight fibers may thus be removed through the filter press filtering process, and then residual diatomaceous earth in which the suspended matters agglomerate is removed through an additional filtering process.

When the raw-material juice contains a great deal of suspended matters, it may be difficult to perform combined concentration because the suspended matters form a hard layer during a concentration process.

The filtering may reduce an amount of suspended matters in the raw-material juice and prevent solidification of the suspended matters during the concentration process.

In an example embodiment, the preparation method of the present application may be concentrating to keep an antioxidant material or a flavor component of a raw material at a high content in a raw-material concentrate, or concentrating to keep a heating flavor component of a raw material at a low content.

Specifically, it may be concentrating to keep any one or more of thiosulfate, a sulfur-containing compound, glutamic acid, histidine, and arginine at a high content. Specific details of each compound will be described later, but are not limited to an onion concentrate.

In addition, specifically, it may be concentrating to keep any one or more of furan-based compounds, a pyrazine-based compound, and phenylalanine at a low content. Specific details of each compound will be described later, but are not limited to an onion concentrate.

In an example embodiment, the preparation method of the present application may be concentrating to keep the turbidity of a prepared raw-material concentrate low. Specific details of the turbidity will be described later, but are not limited to an onion concentrate.

In another aspect, the present application provides a method for enhancing the flavor of a raw-material concentrate, the method comprising: concentrating raw-material juice by thin-film concentration; and concentrating the thin film-concentrated raw-material juice. By film-concentration

In the method for enhancing the flavor of a raw-material concentrate of the present application, concentrating of raw-material juice by thin-film concentration and concentrating of the thin film-concentrated raw-material juice by plate-concentration are the same as those described in the method for preparing a raw-material concentrate, which is an aspect of the present application, and thus the descriptions will not be repeated to avoid excessive complexity of the specification.

In another aspect, the present application provides an onion concentrate.

The onion concentrate may be an onion concentrate comprising 600 μg/ml or more of thiosulfinate. In an example embodiment, the onion concentrate may contain 600 μg/ml or more of thiosulfinate with respect to the total solid content of 60 Brix°.

The content of thiosulfinate in the onion concentrate of the present application may having a lower limit of 600 μg/ml, 610 μg/ml, 620 μg/ml, 630 μg/ml, 640 μg/ml, or 650 μg/ml with respect to the total solid content of 60 Brix°, and an upper limit of 1500 μg/ml, 1000 μg/ml, or 800 μg/ml, with respect to the total solid content of 60 Brix°. In addition, the content of thiosulfinate in the onion concentrate may be in the range in which one selected from the lower limits described above is combined with one selected from the upper limits described above, and may be, for example, 600 μg/ml to 1500 μg/ml, 610 μg/ml to 1500 μg/ml, 610 μg/ml to 1000 μg/ml, 630 μg/ml to 1500 μg/ml, or 630 μg/ml to 1000 μg/ml, and the like.

When thiosulfinate is included in the above range, the onion concentrate may keep unique flavor of a raw-material onion, and the raw-material onion concentrate may be used as a material for foods such as sauces.

In an example embodiment, the onion concentrate may contain 3 mol/L or more of Pyruvic acid with respect to the total solid content of 60 Brix°. For example, with respect to the total solid content of 60 Brix°, the content of pyruvic acid may be 3 mol/L to 10 mol/L, 3.7 mol/L to 10 mol/L, 3.7 mol/L to 8 mol/L, 3.8 mol/L to 6 mol/L, or 3.8 mol/L to 5 mol/L. When pyruvic acid is included in the above range, the onion concentrate may keep a spicy taste of raw-material onions, and may thus be used as a material for imparting a spicy taste to processed foods.

Brix° in the present application expresses an amount of solids in 100 g of a solution as an amount, represented by g, of saccharide (sugar), and Brix°, brix, brix %, bx, and the like may be used interchangeably. The Brix° may be measured through a known method, and may be measured at room temperature of, for example, 15° C. to 35° C.

In the present application, the content of each component with respect to the total solid of a specific Brix° includes one checked after adjusting the content of the total solid through a corresponding Brix°. For example, when the content of the total solid is higher than a specific Brix°, the content may be identified by diluting using an appropriate solvent such as water, and when the content of the total solid is lower than a specific Brix°, measurement may be performed by concentrating to provide the least effect on the content of each component through a known concentration method. The known concentration method may be one using the concentration method of the present invention.

In an example embodiment, the onion concentrate may include a sulfur-containing compound.

The onion concentrate may include any one or more sulfur-containing compounds among dimethyltrisulfide, methylpropyltrisulfide, and 1,3-dithiane.

In addition, the onion concentrate may further include at least one compound selected from the group consisting of 5-diethyl-1,2,3-trithiolane, dipropyltrisulfide, methyl 2-propenyldisulfide, methylthiirane, dimethyldisulfide, trisulfidedimethyl, methylpropyltrisulfide, methyl 1-propenyldisulfide, 2,4-dimethylthiophene, 2,5-dimethylthiophene, dipropyldisulfide, 3-methylthiophene, disulfidediaryl, and sulfidediaryl, in addition to the dimethyltrisulfide, the methylpropyltrisulfide, and the 1,3-dithiane above.

The content of the sulfur-containing compound may have a lower limit of 100 μg/ml, 150 μg/ml, 180 μg/ml, 200 μg/ml, 210 μg/ml, 220 μg/ml, 240 μg/ml, or 250 μg/ml, and the content of the sulfur-containing compound in the onion concentrate may have an upper limit of 1500 μg/ml, 1000 μg/ml, 800 μg/ml, 500 μg/ml, 400 μg/ml, or 300 μg/ml. In addition, the content of the sulfur-containing compound in the onion concentrate may be in the range in which one selected from the lower limits described above is combined with one selected from the upper limits described above, and may be, for example, 100 μg/ml to 1500 μg/ml, 180 μg/ml to 1500 μg/ml, 200 μg/ml to 800 μg/ml, 220 μg/ml to 500 μg/ml, or 250 μg/ml to 400 μg/ml, and the like.

The content of the sulfur-containing compound may be measured with respect to the total solid content of 60 Brix°.

The content of the dimethyltrisulfide may have a lower limit of 20 μg/ml, 50 μg/ml, 100 μg/ml, 105 μg/ml, 107 μg/ml, 110 μg/ml, 113 μg/ml, or 115 μg/ml, and the dimethyltrisulfide in the onion concentrate may have an upper limit of 800 μg/ml, 400 μg/ml, 200 μg/ml, 150 μg/ml, 130 μg/ml, or 125 μg/ml. In addition, the content of the dimethyltrisulfide in the onion concentrate may be in the range in which one selected from the lower limits described above is combined with one selected from the upper limits described above, and may be, for example, 20 μg/ml to 800 μg/ml, 100 μg/ml to 800 μg/ml, 105 μg/ml to 400 μg/ml, 107 μg/ml to 200 μg/ml, or 110 μg/ml to 150 μg/ml, and the like.

The content of the dimethyltrisulfide may be measured with respect to the total solid content of 60 Brix°.

The content of the methylpropyltrisulfide may have a lower limit of 20 μg/ml, 30 μg/ml, 40 μg/ml, 45 μg/ml, 50 μg/ml, 52 μg/ml, 55 μg/ml, or 60 μg/ml, and the content of the methylpropyltrisulfide in the onion concentrate may have an upper limit of 600 μg/ml, 400 μg/ml, 200 μg/ml, 100 μg/ml, 80 μg/ml, or 70 μg/ml. In addition, the content of the methylpropyltrisulfide in the onion concentrate may be in the range in which one selected from the lower limits described above is combined with one selected from the upper limits described above, and may be, for example, 20 μg/ml to 600 μg/ml, 40 μg/ml to 600 μg/ml, 50 μg/ml to 400 μg/ml, 52 μg/ml to 200 μg/ml, or 60 μg/ml to 70 μg/ml, and the like.

The content of the methylpropyltrisulfide may be measured with respect to the total solid content of 60 Brix°.

The content of the 1,3-dithiane may have a lower limit of 5 μg/ml, 10 μg/ml, 20 μg/ml, 25 μg/ml, 30 μg/ml, 32 μg/ml, 35 μg/ml, or 40 μg/ml, and the content of the 1,3-dithiane in the onion concentrate may have an upper limit of 500 μg/ml, 300 μg/ml, 150 μg/ml, 80 μg/ml, 60 μg/ml, or 50 μg/ml. In addition, the content of the 1,3-dithiane in the onion concentrate may be in the range in which one selected from the lower limits described above is combined with one selected from the upper limits described above, and may be, for example, 5 μg/ml to 500 μg/ml, 10 μg/ml to 300 μg/ml, 30 μg/ml to 300 μg/ml, 32 μg/ml to 150 μg/ml, or 40 μg/ml to 50 μg/ml, and the like.

The content of the 1,3-dithiane may be measured with respect to the total solid content of 60 Brix°.

In an example embodiment, the onion concentrate may or may not contain a furan-based compound or a pyrazine-based compound at a low content as measured through GC/MS.

The furan-based compound may be at least one compound selected from the group consisting of 3-methylfuran, 2-methylfuran, 2-ethylfuran, 2,5-dimethylfuran, and 2-(1-pentenyl)furan, and the pyrazine-based compound may be at least one compound selected from the group consisting of methylpyrazine, 2,6-dimethylpyrazine, and 2-ethenyl-6-methylpyrazine.

In the present application, the term “volatile compound” refers to a compound having a property of being dispersed as a gas and evaporating.

When the onion concentrate contains a volatile sulfur-containing compound at a high content, or contains or does not contain a furan-based compound and a pyrazine-based compound at a low level, the onion concentrate may have a spicy taste and unique onion flavor. The content of such volatile compound may be measured through GC/MS.

In an example embodiment, in the onion concentrate, when measured through GC/MS, the content of at least one furan-based compound selected from the group consisting of 3-methylfuran, 2-methylfuran, 2-ethylfuran, 2,5-dimethylfuran, and 2-(1-pentenyl)furan may be 0.1 parts by weight or less with respect to 100 parts by weight of the total volatile component, or may not be detected.

The content of the furan-based compound may have an upper limit of 0.1 parts by weight, 0.08 parts by weight, 0.06 parts by weight, 0.04 parts by weight, 0.02 parts by weight, 0.05 parts by weight, 0.005 parts by weight, and 0.0005 parts by weight, and a lower limit of 0.09 parts by weight, 0.07 parts by weight, 0.05 parts by weight, 0.03 parts by weight, 0.01 parts by weight, 0.0025 parts by weight, 0.00025 parts by weight, and 0.000025 parts by weight. In addition, the content of the furan-based compound may be in the range in which one selected from the lower limits described above is combined with one selected from the upper limits described above, and may be, for example, 0.01 to 0.1 parts by weight, 0.0025 to 0.05 parts by weight, or 0.00025 to 0.01 parts by weight, and the like.

In an example embodiment, in the onion concentrate, when measured through GC/MS, the content of at least one pyrazine-based compound selected from the group consisting of methylpyrazine, 2,6-dimethylpyrazine, and 2-ethenyl-6-methylpyrazine may be 0.1 parts by weight or less with respect to 100 parts by weight of the total volatile component, or may not be detected.

The content of the pyrazine-based compound may have an upper limit of 0.1 parts by weight, 0.08 parts by weight, 0.06 parts by weight, 0.04 parts by weight, 0.02 parts by weight, 0.05 parts by weight, 0.005 parts by weight, and 0.0005 parts by weight, and a lower limit of 0.09 parts by weight, 0.07 parts by weight, 0.05 parts by weight, 0.03 parts by weight, 0.01 parts by weight, 0.0025 parts by weight, 0.00025 parts by weight, and 0.000025 parts by weight. In addition, the content of the pyrazine-based compound may be in the range in which one selected from the lower limits described above is combined with one selected from the upper limits described above, and may be, for example, 0.01 to 0.1 parts by weight, 0.0025 to 0.05 parts by weight, or 0.00025 to 0.01 parts by weight, and the like.

When the content of the furan-based compound and the pyrazine-based compound is within the above range or is not detected, a bitter taste and flavor due to degradation products are suppressed to keep the taste and flavor of a raw-material onion concentrate as they are even after concentration.

The fact that the furan-based compound and the pyrazine-based compound are not detected may indicate that the furan-based compound or the pyrazine-based compound is contained at a concentration below the detection limit of GC/MS. Specifically, the detection limit may be 1,000 ppm (w/w), 100 ppm (w/w), 10 ppm (w/w), 5 ppm (w/w), or 1 ppm (w/w).

In an example embodiment, the onion concentrate may include amino acid.

The amino acid may include any one or more of glutamic acid, histidine, and arginine.

The amino acid may be included in an amount of 10 g/L or more. Specifically, the amount may be 10 g/L to 20 g/L, 10.2 g/L to 20 g/L, or 11 g/L to 15 g/L.

The glutamic acid may be included in an amount of 1.6 g/L or more. Specifically, the amount may be 1.6 g/L to 10 g/L, 1.8 g/L to 10 g/L, 1.9 g/L to 5 g/L, or 1.9 g/L to 3 g/L.

The histidine may be included in an amount of 0.16 g/L or more. Specifically, the amount may be 0.16 g/L to 5 g/L, 0.17 g/L to 5 g/L, 0.17 g/L to 3 g/L, 0.18 g/L to 3 g/L, or 0.19 g/L to 1 g/L.

The arginine may be included in an amount of 4.5 g/L or more. Specifically, the amount may be 4.5 g/L to 10 g/L, 5 g/L to 10 g/L, 5 g/L to 8 g/L, 5 g/L to 7 g/L, or 5.3 g/L to 7 g/L.

The amount of the amino acid, the glutamic acid, the histidine, and the arginine may be measured with respect to the total solid content of 60 Brix°.

When the amino acid, the glutamic acid, the histidine, and the arginine are contained in the above amount, functions to improve the taste of a concentrate and/or health may be included.

In addition, the content of phenylalanine in the amino acid may be 24 parts by weight or less with respect to 100 parts by weight of glutamic acid. Specifically, the content may be 24 parts by weight or less, 23 parts by weight or less, 20 parts by weight or less, or 19 parts by weight or less, and phenylalanine may not be included or may be included at an undetectable content.

When the content of phenylalanine is 24 parts by weight or less with respect to 100 parts by weight of glutamic acid, the concentrate may have less bitter taste.

In an example embodiment, the onion concentrate may have a turbidity of 1,600 NTU or less. Specifically, the turbidity may be 1,600 NTU or less, 1,500 NTU or less, 1400 NTU or less, or 1100 NTU or less. The turbidity may have an unlimited lower limit value including 0, but may be 500 NTU or more.

The turbidity of the onion concentrate may be measured with respect to the total solid content of 60 Brix°.

In another aspect, the present application provides foods containing the onion concentrate.

The foods include, but are not limited to, conventional foods, health foods, and medical (or patient) foods. Specifically, foods are beverages (e.g., dietary fiber beverages, carbonated water, grain powder, teas, and the like), alcoholic beverages, bakery products, sauces (e.g., ketchup, pork cutlet sauce, marinade, and the like), dairy products (e.g., fermented milk, and the like), meat products (e.g., hams, sausages, and the like), chocolate products, gums, candies, jellies, ice cream, syrups, dressings, snacks (e.g., cookies, crackers, and the like), pickled vegetables (e.g., marmalade, sugared extract of fruits, red ginseng extract, or red ginseng slices, and the like), fermented foods (e.g., fermented paste such as soybean paste, processed soybean paste, or red pepper paste), meal replacements (e.g., frozen food, retort food, shelf-stable food, HMR, and the like), or processed foods.

When the onion concentrate of the present application is used for foods, the concentrate of the present application may be added as it is or used together with other food ingredients, and may be appropriately used according to conventional methods. The foods of the present application may contain various sweeteners or natural carbohydrates as additional ingredients. The natural carbohydrates are monosaccharides such as glucose and fructose, disaccharides such as maltose and sucrose, polysaccharides such as dextrin and cyclodextrin, and sugar alcohols such as xylitol, sorbitol, and erythritol. Examples of sweeteners include natural sweeteners such as thaumatin and stevia extract or synthetic sweeteners such as saccharin and aspartame.

In addition to those above, the foods of the present application include various nutrients, vitamins, electrolytes, flavoring agents, colorants, pectin and salts thereof, alginic acid and salts thereof, organic acids, protective colloidal thickeners, pH adjusters, stabilizers, preservatives, glycerin, alcohol, carbonation agents used for carbonated beverages, and the like. In addition, the foods of the present application may contain flesh for preparing natural fruit juice, fruit juice beverage, and vegetable beverage. These ingredients may be used alone or in combination.

The onion concentrate may be included without limitation in the foods above, and may be for example, included in an amount of 0.001 to 50 parts by weight, 0.01 to 30 parts by weight, 0.01 to 20 parts by weight, 0.1 to 10 parts by weight, or 0.1 to 5 parts by weight with respect to 100 parts by weight of food.

The food may be for imparting an antioxidant component, a spicy taste, or flavor of onion to foods.

In another aspect, the present application provides a method for enhancing the flavor of an onion concentrate, the method including: thin film-concentrating raw-material onion juice; and plate-concentrating the thin film-concentrated onion juice.

The onion concentrate, the raw-material onion juice, the thin film-concentration, and the plate-concentration are the same as described above.

### Advantageous Effects

The present application provides a benefit through a method for preparing a raw-material concentrate that has a high extraction yield of active ingredients extracted from raw materials and is economical, and has good flavor as well as less nutrition destruction, and thus has excellent product quality.

The present application provides a benefit through a raw onion concentrate with enhanced flavor, which does not destroy ingredients that give an original taste and savor of onions even after a concentration process, and has unique flavor of onions due to few degradation products and does not cause unpleasant odor.

The present application provides a benefit of using a raw onion concentrate having a high active ingredient content without losing the unique flavor of onions, as a material for processed foods.

### BRIEF DESCRIPTION OF THE DRAWINGS

FIG. 1 shows a configuration of preparation processes of onion juice according to an example embodiment of the present application.

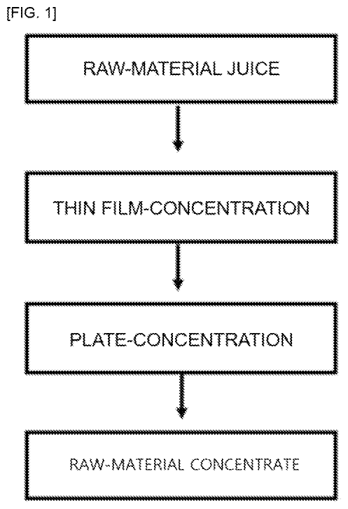

### MODE FOR CARRYING OUT THE INVENTION

Hereinafter, the present invention will be described in more detail with reference to the following Examples. However, these Examples are for illustrative purposes only to describe the present invention, and are not intended to limit the scope of the present invention.

### Preparation Example 1. Preparation of Raw-Material Juice

1-1 Preparation of Raw Material

Raw-material onions harvested from Jeju Special Self-Governing Province were purchased and used. Peeled onions were washed in running water until dirt was completely removed, then packaged and kept refrigerated at 10° C. or less to use the onions as raw materials.

1-2 Pretreatment and Juicing

The initial number of bacteria was controlled by treating the raw-material onions with non-acidic electrolyzed water (HOCl, pH 5.0, 20 ppm) for 30 minutes instead of heating the raw-material onions to keep the flavor of fresh onions. Next, the raw-material onions were primary-crushed and juiced using a juicer (HSJ-120, HANSUNG Co., Kr) to prepare raw-material juice.

1-3 Filtration Process

A two-step filtration process of primary filtration using a filter press (JUNGDO 1000, JUNGDO Co., Kr) and secondary filtration using a 5 μm MF filter was performed to effectively remove impurities of various sizes in the raw-material juice.

Specifically, 5 wt % of diatomaceous earth was added to the raw-material juice with respect to the total weight of the raw-material juice to cause mucous polysaccharide materials to agglomerate on the diatomaceous earth, and then the resultant was filtered through filter press cloth (15 cc) to remove low molecular weight fibers. The raw-material juice subjected to the primary filtration was subjected to secondary filtration using a 5 μm MF filter to further remove residual diatomaceous earth and fine substances, thereby preparing the raw-material juice in a clarified state.

1-4 Measurement of Turbidity

The turbidity of the filtered raw-material juice was measured to check how much suspended matters were removed after the filtration process. Specifically, the turbidity was measured using a turbidimeter (HACH 2001N TURBIDIMETER).

The concentration of the raw-material juice after the two-step filtration process of the present invention was maintained at a low level of 7.3 Brix° and turbidity of 154 NTU.

1-5 Quick Freezing and Storage

The filtered raw-material juice was cooled to 20° C. or lower, packaged by 15 kg each, and then quick-frozen at 18° C. or lower and stored.

### Examples 1 to 4. Combined Process in which Thin Film-Concentration Process and Plate-Concentration Process are Linked

The raw-material onion juice prepared through the method of Preparation Example 1 was concentrated using a combination of a thin film-concentration method and a plate-concentration method.

Specifically, a centrifugal thin film concentrator (CEP-1, OKAWARA CO., Japan) was set to an evaporation temperature of 30° C. to 35° C., a heating medium temperature of 100° C., a vacuum degree of 4.0 kPa, and a drum speed of 1500 rpm for optimization.

Initial onion juice was concentrated up to the solid content of 20 Brix° (Example 1), 30 Brix° (Example 2), 40 Brix° (Example 3), and 50 Brix° (Example 4). The above process was repeated up to a target concentration.

Thereafter, the plate-concentration was optimized at an evaporation temperature of 30° C. to 35° C., a heating medium temperature of 60° C. or less, and a vacuum degree of 2.0 kPa, and performed up until the concentration of a finally prepared onion concentrate reached 60 Brix°.

The finally prepared raw-material onion concentrate was stored at 20° C. or less, and the content of active ingredients and main quality characteristics according to the concentration methods and concentration conditions were checked.

### Comparative Example 1. General Vacuum Concentration Process

A raw-material onion concentrate was prepared using a general concentrate preparation method.

Raw-material onion juice was prepared by heat-juicing. Specifically, the same raw material as in Preparation Example 1-1 was extracted at 90° C. to 100° C. for 60 minutes, and then subjected to filtration (80 mesh), cooling (20° C. or less), packaging, and quick freezing (−18° C. or less) to prepare raw-material onion juice. The juice had a concentration of 7.7 Brix° and a turbidity of 549 NTU.

The prepared onion raw-material juice was vacuum-concentrated using a commonly used batch-type vacuum concentrator (PILOT, Seo kang, Co., Kr). Specifically, the vacuum concentrator was set to an evaporation temperature of 45° C. to 50° C., a heat medium temperature of 60° C. or higher, and a vacuum degree of 9.0 kPa, and then the prepared raw-material onion juice was stirred to prepare raw-material onion concentrate.

### Comparative Example 2. Optimized Thin Film-Concentration Process

The raw-material onion juice prepared through the method of Preparation Example 1 was put into a centrifugal thin film concentrator to obtain a raw-material onion concentrate.

Equipment using a centrifugal thin film concentrator, temperature, and the like were set in the same manner as in Example, and the concentrate was recycled until the concentrate reached a concentration of 40 Brix° to prepare a raw-material onion concentrate.

### Comparative Example 3. Optimized Plate-Concentration Process

The raw-material onion juice prepared through the method of Preparation Example 1 was put into a plate-concentrator to obtain a raw-material onion concentrate.

Specifically, the plate-concentration process was performed under the same conditions in equipment and temperature as in Example, and a raw-material onion concentrate of 60 Brix° was prepared.

That is, Comparative Example 3 skipped thin film-concentration process unlike Example.

### Experimental Example 1 Observation of Changes in Turbidity, Browning, and pH of Raw-Material Concentrates According to Concentration Process

Changes in turbidity, browning, and pH of various raw-material onion concentrates prepared through the methods of Examples and Comparative Examples were checked.

Turbidity was measured using a turbidimeter (HACH 2100N TURBIDIMETER), and browning was measured using a spectrophotometer (U-2900, HITACHI, Co., Japan) for absorbance at 420 nm, and pH was measured using a pH meter (METTLER TOLEDO).

TABLE 1

| | Turbidity | Browning | |
|---|---|---|---|
| Concentration method | (NTU) | (Abs) | pH |
| Comparative Example 1 | 1778 | 2.051 | 5.39 |
| (Vacuum Concentration, | | | |
| 60 Brix°) | | | |
| Comparative Example 2 | 1283 | 1.554 | 5.60 |
| (Thin film-concentration, | | | |
| 40 Brix°) | | | |
| Comparative Example 3 | 1120 | 1.896 | 5.36 |
| (Plate-concentration, | | | |
| 60 Brix°) | | | |
| Example 1 (20 Brix°->60 Brix°) | 814 | 1.875 | 5.43 |
| Example 2 (30 Brix°->60 Brix°) | 960 | 1.897 | 5.59 |
| Example 3 (40 Brix°->60 Brix°) | 1050 | 1.920 | 5.59 |
| Example 4 (50 Brix°->60 Brix°) | 1394 | 1.965 | 5.39 |

As shown in Table 1, the results indicated that turbidity and browning changed depending on concentration methods, and the combined concentration (Examples 1 to 4) had a decrease in turbidity and browning compared to vacuum concentration (Comparative Example 1), which is a conventional concentration method.

### Experimental Example 2. Observation of Changes in Chromaticity of Raw-Material Concentrate According to Concentration Process

The chromaticity of various raw-material onion concentrates prepared through the methods of Examples and Comparative Examples was measured through Hunter's method.

In the chromaticity measurement of raw-material concentrates, lightness (L, lightness), redness (a, redness), yellowness (b, yellowness), and ΔE values indicating overall color difference were measured using a colorimeter (SA-2000, NIPPON Denshoku Co., Japan), and the measurement was repeated three times for each sample and expressed as an average value. The standard white plate used for this measurement had an L value of 98.01, an a value of 2.27, and a b value of 1.13.

TABLE 2

| Concentration method | L | a | b | ΔE |
|---|---|---|---|---|
| Comparative Example 1 | 6.41 | 4.31 | 4.02 | 78.02 |
| (Vacuum Concentration, | | | | |
| 60 Brix°) | | | | |
| Comparative Example 2 | 41.93 | 4.46 | 9.54 | 42.69 |
| (Thin film-concentration, | | | | |
| 40 Brix°) | | | | |
| Comparative Example 3 | 9.75 | 2.93 | 5.43 | 76.20 |
| (Plate-concentration, | | | | |
| 60 Brix°) | | | | |
| Example 1 (20 Brix°->60 Brix°) | 11.41 | 3.66 | 6.45 | 74.12 |
| Example 2 (30 Brix°->60 Brix°) | 10.06 | 3.05 | 5.56 | 75.49 |
| Example 3 (40 Brix°->60 Brix°) | 9.52 | 3.23 | 5.42 | 76.04 |
| Example 4 (50 Brix°->60 Brix°) | 7.51 | 2.24 | 4.27 | 78.08 |

As shown in Table 2, the results indicated that the raw-material concentrates (Examples 1 to 4) prepared through the combined concentration had higher brightness, lower redness, higher yellowness, and relatively lower ΔE value indicating the overall color difference than that of the conventional concentration method (Comparative Example 1). The lower the ΔE value, the less the color deviation, and the higher the DE value, the greater the deviation, and thus the results indicate that the raw-material concentrates prepared through the combined concentration had less changes in color upon the concentration process.

### Experimental Example 3. Observation of the Content of Each Amino Acid by Type in Raw-Material Concentrate According to Concentration Process

The content of amino acid in various raw-material onion concentrates prepared through the methods of Examples and Comparative Examples was analyzed and is shown in Table 3 below.

For amino acid content analysis, 9.9 mL of distilled water was added to 0.1 mL of a sample solution, thoroughly mixed, and centrifuged (10,000 rpm, 10 min, 4° C.), and the resultant supernatant was filtered using a 0.25 μm syringe filter. Measurement of amino acid for the filtrate was analyzed using a High Speed Amino Acid Analyzer (L-8900, Hitachi Co., Japan).

For the analysis, a 2622SC-PH ion exchange column (4.6×60 mm, Hitachi, Co., Japan) was used as a column. A mobile phase was set to gradient mode, and in Pump1, sodium acetate buffer (MCI buffers PH1, PH4, RG) was used at a column temperature of 57° C. and a flow rate of 0.4 mL/min, and in Pump 2, a ninhydrin solution (R1 and R2) was used at a flow rate of 0.35 mL/min. 10 μL of injection volume was injected and as for a detector, Channel 1:UV-570 nm and Channel 2:UV-440 nm were used as dual channels for analysis.

TABLE 3

| | Comparative | Comparative | Comparative | | | | |
|---|---|---|---|---|---|---|---|
| Element | Example 1 | Example 2 | Example 3 | Example 1 | Example 2 | Example 3 | Example 4 |
| Aspartic | ND | ND | ND | ND | ND | ND | ND |
| acid | | | | | | | |
| Serine | 547.2 | 384.0 | 457.3 | 565.2 | 299.5 | ND | 560.8 |
| Glutamic | 1806.3 | 1355.3 | 1556.6 | 2037.3 | 1907.6 | 1907.2 | 1808.1 |
| acid | | | | | | | |
| Glycine | 86.5 | 59.9 | 64.0 | 53.9 | 89.2 | 82.9 | 68.7 |
| Alanine | 658.0 | 465.7 | 532.2 | 625.9 | 748.0 | 734.8 | 655.7 |
| Cysteine | ND | ND | ND | ND | ND | ND | ND |
| Valine | 347.7 | 289.1 | 310.0 | 358.2 | 362.3 | 342.7 | 376.1 |
| Methionine | 75.5 | 75.5 | 66.8 | 30.2 | 68.4 | 61.2 | 48.7 |
| Isoleucine, | 168.2 | 120.8 | 138.2 | 184.2 | 149.9 | 136.4 | 199.5 |
| Leucine | 517.3 | 397.0 | 445.4 | 476.3 | 526.8 | 497.7 | 591.8 |
| Tyrosine | 396.3 | 302.5 | 318.9 | 390.7 | 353.3 | 337.4 | 407.4 |
| Phenylalanine | 436.9 | 297.4 | 342.4 | 300.1 | 361.2 | 345.8 | 411.4 |
| Lysine | 787.5 | 631.5 | 751.9 | 859.7 | 735.3 | 237.4 | 947.4 |
| Histidine | 161.0 | 121.1 | 150.4 | 185.7 | 204.3 | 197.2 | 204.1 |
| Arginine | 4825.9 | 3431.7 | 4142.3 | 5235.6 | 5557.6 | 5376.9 | 5441.8 |
| Total | 10814.3 | 7931.3 | 9276.4 | 11134.0 | 11363.2 | 10257.6 | 11721.5 |

(Unit: mg/L)

As shown in Table 3, the results indicated that the raw-material concentrates prepared through the combined concentration, had a greater content of amino acid in total than the conventional concentration method (Comparative Example 1) and the single concentration (Comparative Examples 2 and 3).

In addition, it was confirmed that, compared to Comparative Examples, Examples showed a decrease in the content of phenylalanine, which gives a bitter taste and an increase in the content of glutamic acid, which gives a savory taste in the raw-material concentrates to enhance the flavor of the raw-material concentrates, and Examples showed an increase in the content of histidine and arginine, which are antioxidants, in the raw-material concentrates. The changes in the content of these amino acid components seem to indicate that some heat-labile amino acids are continuously exposed to heat to react with other components or decompose to produce volatile flavor components, or to be converted into other types of amino acids, and it seems that the increase in the content of some amino acids is caused by the release of amino acids that are not sufficiently released during the concentration process.

### Experimental Example 4. Observation of Flavor Enhancement Index Component in Raw-Material Concentrate According to Concentration Process

Pyruvic acid, which is a pungent indicator component of garlic and onion, is lost by heat, and thiosulfinate, a sulfur-containing compound of onion and an antioxidant, is also known to decrease its characteristic component by heat. The content of thiosulfinate and pyruvic acid in various raw-material onion concentrates prepared through the methods of Examples and Comparative Examples was analyzed and is shown in Table 4 below.

Measurement of the Content of Thiosulfinate

0.5 mL of 50 mM N-(2-Hydroxyethyl)piperazine-N′-(2-ethane sulfonic acid) (HEPES, pH 7.5, Sigma, U.S.A.) including 2 mM cysteine (Sigma, U.S.A.), 0.1 mL of an extract, and 4.4 mL of 50 mM HEPES were mixed to make a total of 5 mL (0.2 mM cysteine/mL) subjected to a reaction at 27° C. for 10 minutes, thereby collecting 1 mL, and then 1 mL of 0.4 mM 5,5′-dithio-bis(2-nitrobenzoic acid) (DTNB, Sigma, U.S.A.) prepared with 50 mM HEPES buffer (pH7.5) was added thereto and subjected to a reaction at 27° C. for 10 minutes to measure absorbance at 412 nm, thereby identifying the content of residual cysteine. The standard curve was plotted by mixing 1 mL of 0.05 to 0.3 mM cysteine prepared with 50 mM HEPES buffer (pH 7.5) and 1 mL of 0.4 mM DTNB to make the mixture react at 27° C. for 10 minutes, thereby measuring absorbance at 412 nm. The content of cysteine was identified from the standard curve to see the total content of thiosulfinate through [Equation 1], and in a control group, a buffer solution was added instead of an extract solution to develop color, and samples affected by pigment were measured by adding the extract solution of the samples instead of DTNB, which is a coloring agent, and subtracted from the absorbance in which the samples were added and reacted.

Total thiosulfinate (mM/mL)=[Ab−(As−Ac)]×25 [Equation 1]

Ab: Content of cysteine in control group (mM/mL)

As: Content of cysteine with extract solution (mM/mL)

As: Content of cysteine affected by pigment contained in extract solution (mM/mL)

Measurement of the Content of Pyruvic Acid

4 mL of 0.0125% DNPH (2,4-dinitrophenylhydrazine) was added to 80 μL of supernatant of a raw onion concentrate, and the mixture was shaken, and subjected to a reaction at 37° C. for 10 minutes. 8 mL of 0.6 N NaOH solution was added to measure absorbance at 485 nm, and the concentration of pyruvic acid was converted using a standard curve. The standard curve was plotted with sodium pyruvate solution concentrations of 2, 4, 6, 8, and 10 mg/mL.

TABLE 4

| | Thiosulfinate | Pyruvic acid |
|---|---|---|
| Concentration method | (ug/mL) | (mol/L) |
| Comparative Example 1 | 296.5 | 3.61 |
| (Vacuum Concentration, | | |
| 60 Brix°) | | |
| Comparative Example 2 | 477.5 | 3.46 |
| (Thin film-concentration, | | |
| 40 Brix°) | | |
| Comparative Example 3 | 582.4 | 3.78 |
| (Plate-concentration, | | |
| 60 Brix°) | | |
| Example 1 (20 Brix°->60 Brix°) | 638.0 | 3.05 |
| Example 2 (30 Brix°->60 Brix°) | 713.9 | 4.02 |
| Example 3 (40 Brix°->60 Brix°) | 658.2 | 3.89 |
| Example 4 (50 Brix°->60 Brix°) | 646.5 | 3.10 |

As a result, as shown in Table 4, it is shown that while thiosulfinate, which is a standard of a sulfur-containing compound, was included in an amount of 296.5 μg/mL in Comparative Example 1, thiosulfinate was included in an amount of 638 μg/mL to 713.9 μg/mL in the raw material concentrates prepared through the combined concentration method, indicating that the concentration efficiency was more than twice that of Comparative Example 1. In addition, while pyruvic acid, which is an indicator of a spicy taste, was contained in an amount of 3.61 mol/L in Comparative Example 1, in the combined concentration, pyruvic acid was included in an amount of 3.89 mol/L to 4.02 mol/L in the raw material concentrates prepared through the plate-concentration at a point where the solid content reached 30 Brix° to 40 Brix° by thin film-concentrating the raw-material juice, indicating an increase in the amount of pyruvic acid compared to Comparative Example 1. This is, considering the level of heat transferred per unit time and the concentration efficiency when the concentration is performed in large amounts, it is shown that compared to Comparative Examples 1 to 3, when the raw-material juice is concentrated through the combined concentration method of Examples, changes in quality of raw-material onions may be minimized.

### Experimental Example 5. Observation of Flavor Enhancement Index Component in Raw Material Concentrate According to Concentration Process

Sulfur-containing compounds, which are said to be a main flavor component of onions, are known to be lost by heat. The flavor components in various raw-material onion concentrates prepared through the methods of Examples and Comparative Examples were analyzed through GC/MS and are shown in Tables 5 to 8 below. The analysis of volatile flavor substances was performed as follows.

Volatile Substance Analysis Method

The following method was used to identify flavor components of an extract. The adsorption for the analysis of volatile substances was pretreated using DVB/CAR/PDMS (50/30 μm) for SPME (Solid Phase Microextraction Fiber Holder, Supelco., Bellefonte, Pa., USA). 1 mL of the pre-treated extract was placed in a 20 mL EPA vial and capped with PTFE/Silicon. A SPME needle was inserted into the vial to which the extract was added, and the obtained was used for GC/MS analysis after adsorption at 60° C. for 30 minutes.

Agilent gas chromatograph (GC2010 plus, Agilent, USA) was used for GC/MS analysis, and DB-5MS (thickness: 0.25 μm, length: 30 m, diameter: 0.25 mm) was used for column. He was used as a carrier gas, and analysis was performed after conditions were set to a column oven temperature of 100° C., an injection temperature of 200° C., a total flow of 1.10 mL/min, and a total program time of 37 min.

In the GC/MS analysis, the detection limit was confirmed to be 1 ppm (weight ratio).

TABLE 5

| | Comparative | Comparative | Comparative | | | | |
|---|---|---|---|---|---|---|---|
| Element | Example 1 | Example 2 | Example 3 | Example 1 | Example 2 | Example 3 | Example 4 |
| Sulfur-containing | 114,341 | 419,695 | 216,719 | 207,986 | 213,129 | 207,165 | 199,741 |
| compounds | | | | | | | |
| 1,2,4-Trithiolane, | ND | 57,561 | 6,471 | 8,374 | 4,017 | ND | 9,261 |
| 3,5-diethyl- | | | | | | | |
| Trisulfide, | 1,784 | 28,168 | 11,047 | 9,149 | 12,411 | 11,492 | 10,056 |
| dipropyl | | | | | | | |
| Disulfide, methyl | 3,091 | 5,222 | 1,754 | 1,588 | 1,988 | 1,968 | 1,671 |
| 2-propenyl | | | | | | | |
| Thiirane, methyl- | 9,649 | 35,318 | 13,763 | 13,225 | 17,505 | 16,939 | 13,565 |
| Disulfide, dimethyl | 13,279 | 16,409 | 8,397 | 8,956 | 9,879 | 8,868 | 6,940 |
| Dimethyl trisulfide | 60,809 | 175,167 | 115,116 | 108,689 | 106,796 | 107,172 | 102,084 |
| Trisulfide, methyl | 25,729 | 101,850 | 60,171 | 58,004 | 60,534 | 60,726 | 56,165 |
| propyl | | | | | | | |
| 1,3-Dithiane | 326 | 29,592 | 24,347 | 29,657 | 26,155 | 35,054 | 22,666 |

(Unit: peak area/10000)

As shown in Table 5 above, it is seen that the sulfur compound had a lower strength in the vacuum concentration method of Comparative Example 1, and the onion concentrate concentrated through the combined concentration of Example had some differences depending on the time of the combination, but had an increase or a decrease in some sulfur-containing compounds.

TABLE 6

| | Comparative | Comparative | Comparative | | | | |
|---|---|---|---|---|---|---|---|
| Element | Example 1 | Example 2 | Example 3 | Example 1 | Example 2 | Example 3 | Example 4 |
| Heterocyclic | 34,094 | 109,418 | 94,378 | 83,193 | 94,244 | 69,929 | 88,440 |
| compounds | | | | | | | |
| Furan, 3-methyl- | 33 | ND | ND | ND | ND | ND | ND |
| Furan, 2-methyl- | 52 | ND | ND | ND | ND | ND | ND |
| Furan, 2-ethyl- | 260 | ND | ND | ND | ND | ND | ND |
| Furan, 2,5- | 145 | ND | ND | ND | ND | ND | ND |
| dimethyl- | | | | | | | |
| 2,4-Dimethylfuran | 3,334 | 3,723 | 3,284 | 4,325 | 3,329 | 3,149 | 3,448 |
| Furan, 2-pentyl- | 783 | 730 | 413 | 218 | 376 | 267 | 208 |
| Furan, 2-(1- | 545 | ND | ND | ND | ND | ND | ND |
| pentenyl)-, (E)- | | | | | | | |
| Furan, 2-methyl-5- | 1,420 | ND | 12,429 | ND | 12,817 | ND | 8,639 |
| (methylthio)- | | | | | | | |
| Furan, 2,5- | 187 | ND | ND | 388 | 147 | ND | 166 |
| dihydro-2,5- | | | | | | | |
| dimethyl- | | | | | | | |
| Pyrazine, methyl- | 382 | ND | ND | ND | ND | ND | ND |
| Pyrazine, 2,6- | 2,445 | ND | ND | ND | ND | ND | ND |
| dimethyl- | | | | | | | |
| Pyrazine, 2- | 362 | ND | ND | ND | ND | ND | ND |
| ethenyl-6-methyl- | | | | | | | |
| Thiophene, 2,5- | 534 | 999 | 406 | 448 | 525 | 470 | 485 |
| dimethyl- | | | | | | | |
| Thiophene, 2,4- | 468 | 4,796 | 2,153 | 1,777 | 2,550 | 2,177 | 2,211 |
| dimethyl- | | | | | | | |
| Thiophene, 3,4- | 19,123 | 58,589 | 42,114 | 48,709 | 47,872 | 40,538 | 45,749 |
| dimethyl- | | | | | | | |
| Thiophene, 3,5- | 1,907 | ND | ND | ND | ND | ND | ND |
| dimethyl-2- | | | | | | | |
| (methylthio)- | | | | | | | |
| Thiophene, 2- | 187 | ND | ND | ND | 223 | ND | ND |
| methyl- | | | | | | | |
| Thiophene, 2- | 987 | ND | 12,429 | 10,606 | 9,981 | 9,661 | 8,303 |
| methoxy-5-methyl- | | | | | | | |
| Thiophene, 2,3- | 891 | ND | ND | ND | ND | ND | ND |
| dimethyl- | | | | | | | |
| Thiophene, | 48 | ND | ND | ND | ND | ND | ND |
| tetrahydro-3- | | | | | | | |
| methyl- | | | | | | | |
| Thiophene, 2- | ND | 40,581 | 20,798 | 15,540 | 15,635 | 13,140 | 18,902 |
| nitro- | | | | | | | |
| Thiophene, 3- | ND | ND | 353 | 346 | 535 | 110 | 331 |
| methoxy- | | | | | | | |
| Thiophene, 3- | ND | ND | ND | 193 | ND | 105 | ND |
| methyl- | | | | | | | |
| Thiophene | ND | ND | ND | 643 | 253 | 312 | ND |

(Unit: peak area/10000)

The heterocyclic compound shown in Table 6 is a compound produced by the Maillard reaction that occurs between an amino acid and a reducing sugar, and in Comparative Example 1, a variety of furan-based compounds and pyrazine-based compounds, which are typical heat-induced reaction materials, were detected. On the other hand, pyrazine-based compounds were not detected in the onion concentrates of Comparative Examples 2 to 3 and Examples, and only some of the furan compounds were detected in small amounts. The furan compounds with values having a peak area/10,000 value of about 1,000 or less were included in an amount of about 0.1 part by weight out of 100 parts by weight of a volatile component, indicating that a fairly small amount was included.

TABLE 7

| | Comparative | Comparative | Comparative | | | | |
|---|---|---|---|---|---|---|---|
| Element | Example 1 | Example 2 | Example 3 | Example 1 | Example 2 | Example 3 | Example 4 |
| Miscellaneous | 4,122 | 5,879 | 2,946 | 3,621 | 4,495 | 2,038 | 1,834 |
| compounds | | | | | | | |
| 2-Pentenal, 2- | 2,615 | 5,879 | 2,946 | 3,621 | 4,495 | 2,038 | 1,834 |
| methyl- | | | | | | | |
| 1-Propanone, 1-(2- | 371 | ND | ND | ND | ND | ND | ND |
| furanyl)- | | | | | | | |
| Butanal, 3-methyl- | 1,135 | ND | ND | ND | ND | ND | ND |

(Unit: peak area/10000)

In addition, as shown in Table 7 above, it is seen that 2-methyl-2-Pentenal, which is a main flavor component of raw onions, showed low strength in Comparative Example 1, resulting in reduced characteristics of the raw onions, while the flavor of the raw onions was specifically increased in the onion concentrates of Examples in which the combined concentration was performed at an appropriate time point. In addition, 1-(2-furanyl)-1-Propanone, which is known as heated odor of onions, and 3-methyl-butanal produced by oxidative decomposition of fat were produced only in Comparative Example 1, and were not produced in Comparative Examples 2-3 and Examples.

Therefore, in each concentration process for achieving unique flavor of a raw material, the thin film-concentration process of Comparative Example 2 does not generate the intensity of flavor and thermal reaction-inducing materials, but is expected to produce the thermal reaction materials at a higher concentration, and thus is not suitable for high concentration, and the plate-concentration process of Comparative Example 3 designed to optimize the conditions for combined concentration seems to have no significant difference from the combined concentration process due to less change in quality than commercialization conditions, but considering the concentration efficiency per unit time, it is determined that the combined concentration process of Examples is most advantageous for achieving the unique flavor of a raw material.

Meanwhile, the sulfur-containing compound was quantitatively analyzed to identify the content of each component of the sulfur-containing compound contained in the raw-material onion concentrate, and is shown in Table 8.

The sulfur-containing compound was quantified by adding 100 μL of 100 mg/L n-butylbenzene as an internal standard to 1.0 g of a sample and calculating the content of volatile flavor components in the sample with comparative relative quantification.

TABLE 8

| | Comparative | Comparative | Comparative | | | | |
|---|---|---|---|---|---|---|---|
| Element | Example 1 | Example 2 | Example 3 | Example 1 | Example 2 | Example 3 | Example 4 |
| 1,2,4-Trithiolane, | ND | ND | ND | ND | ND | ND | ND |
| 3,5-diethyl- | | | | | | | |
| Trisulfide, | 1.00 | 19.88 | 11.16 | 8.59 | 12.32 | 12.47 | 7.97 |
| dipropyl | | | | | | | |
| Disulfide, methyl | 0.85 | 2.19 | 1.28 | 1.18 | 1.32 | 1.25 | 1.05 |
| 2-propenyl | | | | | | | |
| Thiirane, methyl- | 0.52 | 5.12 | 13.46 | 10.02 | 11.75 | 9.09 | 10.7 |
| Disulfide, dimethyl | 1.51 | 7.65 | 6.31 | 5.64 | 7.41 | 7.60 | 5.39 |
| Dimethyl trisulfide | 9.32 | 108.84 | 109.73 | 110.26 | 120.36 | 115.71 | 105.59 |
| Trisulfide, methyl | 7.19 | 75.02 | 59.57 | 57.08 | 64.59 | 64.34 | 54.14 |
| propyl | | | | | | | |
| Disulfide, methyl | 0.00 | 0.47 | 0.59 | 0.42 | 0.82 | 0.67 | 0.43 |
| 1-propenyl | | | | | | | |
| Thiophene, 2,4- | 0.09 | 1.72 | 2.49 | 2.02 | 2.48 | 1.92 | 2.33 |
| dimethyl- | | | | | | | |
| Thiophene, 2,5- | 3.13 | 0.66 | 0.75 | 0.70 | 0.69 | 0.62 | 0.72 |
| dimethyl- | | | | | | | |
| 1,3-Dithiane | 1.01 | 39.08 | 39.90 | 31.34 | 46.48 | 40.78 | 36.23 |
| disulfide, dipropyl | ND | ND | ND | ND | 2.150 | ND | 0.23 |
| Thiophene, 3- | ND | ND | ND | ND | ND | ND | ND |
| methyl- | | | | | | | |
| Diallyl disulphide | ND | ND | 1.34 | 0.87 | 1.50 | 1.58 | 1.01 |
| Diallyl sulfide | ND | ND | ND | ND | 0.09 | 3.99 | 0.23 |
| Total | 24.99 | 261.2 | 247.04 | 228.52 | 272.40 | 260.62 | 226.36 |

(Unit: ppm)

The content of each component of the sulfur-containing compound showed a similar tendency to the results of identifying flavor components. In the sulfur-containing compound, methyl trisulfide, dimethyl trisulfide, and 1,3-dithiane, which are major flavor components, were observed to have the highest content in the raw-material onion concentrates of Examples, and the onion concentrate prepared through the vacuum concentration process of Comparative Example 1 was observed to have a relatively low content.

1. A method for preparing a raw-material concentrate, the method comprising:
concentrating raw-material juice by thin-film concentration; and
concentrating the thin film-concentrated raw-material juice by plate-concentration.

2. The method of claim 1, wherein the solid content of the raw-material juice after the thin film-concentration is 20 Brix° to 50 Brix°.

3. The method of claim 1, wherein the solid content of the prepared raw-material concentrate is 60 Brix° or more.

4. The method of claim 1, wherein the raw material is at least one selected from the group consisting of fruits, fruit vegetables, and vegetables.

5. The method of claim 1, wherein the method increases the content of a sulfur-containing compound through the thin film-concentration and the plate-concentration, and inhibits the generation of a furan-based compound or a pyrazine-based compound.

6. The method of claim 1, wherein the thin film-concentration is performed through heat treatment such that an evaporation temperature reaches 20° C. to 50° C.

7. The method of claim 1, wherein the plate-concentration is performed through heat treatment such that an evaporation temperature reaches 30° C. to 35° C.

8. The method of claim 1, wherein the raw-material juice has a turbidity of 1600 NTU or less with respect to the solid content of 7 to 8 Brix°.

9. An onion concentrate containing 600 μg/ml or more of thiosulfinate.

10. The onion concentrate of claim 9, wherein the onion concentrate comprises 600 μg/ml or more of thiosulfinate with respect to the total solid content of 60 Brix°.

11. The onion concentrate of claim 9, wherein the onion concentrate comprises at least one compound selected from the group consisting of dimethyltrisulfide, methylpropyltrisulfide, and 1,3-dithiane.

12. The onion concentrate of claim 11, wherein in the onion concentrate, when measured through GC/MS, the content of at least one furan-based compound selected from the group consisting of 3-methylfuran, 2-methylfuran, 2-ethylfuran, 2,5-dimethylfuran, and 2-(1-pentenyl)furan is 0.1 parts by weight or less with respect to 100 parts by weight of an onion concentrate volatile component, or
the content of at least one pyrazine-based compound selected from the group consisting of methylpyrazine, 2,6-dimethylpyrazine, and 2-ethenyl-6-methylpyrazine is 0.1 parts by weight or less with respect to 100 parts by weight of an onion concentrate volatile component.

13. A food comprising the onion concentrate of claim 9.

14. A method for enhancing the flavor of a raw-material concentrate, the method comprising:
concentrating raw-material juice by thin-film concentrating; and
concentrating the thin film-concentrated raw-material juice by plate-concentration.

15. The method of claim 14, wherein the raw-material concentrate is an onion concentrate.

16. A food comprising the onion concentrate of claim 10.

17. A food comprising the onion concentrate of claim 11.

18. A food comprising the onion concentrate of claim 12.
